(19) United States
(12) Patent Application Publication
(10) Pub. No.: US 2024/0262415 A1
(43) Pub. Date: Aug. 8, 2024

(54) DRIVING SUPPORT METHOD AND DRIVING SUPPORT APPARATUS FOR VEHICLE

(71) Applicant: TOYOTA JIDOSHA KABUSHIKI KAISHA, Toyota-shi (JP)

(72) Inventors: Shunta SANO, Susono-shi (JP); Masamu CHIBA, Numazu-shi (JP)

(73) Assignee: TOYOTA JIDOSHA KABUSHIKI KAISHA, Toyota-shi (JP)

(21) Appl. No.: 18/535,285

(22) Filed: Dec. 11, 2023

(30) Foreign Application Priority Data
Feb. 7, 2023 (JP) 2023-016862

(51) Int. Cl. B62D 6/00; G08G 1/16

(52) U.S. Cl. CPC B62D 6/001; G08G 1/16

(57) ABSTRACT

A method for supporting driving of a vehicle includes: a step of performing departure preventing control including steering control for preventing the vehicle from departing from a driving lane for the vehicle; and a step of starting, when an operative condition for risk avoiding control including steering control for avoiding a risk factor ahead of the vehicle is satisfied during performance of the departure preventing control, the risk avoiding control from an end timing of the departure preventing control. The operative condition for the risk avoiding control includes that a longitudinal distance from the vehicle to the risk factor is not more than a reference distance. The method further includes a step of expanding the reference distance during performance of the departure preventing control.

### CROSS-REFERENCE TO RELATED APPLICATION

This application claims priority to Japanese Patent Application No. 2023-016862 filed on Feb. 7, 2023, incorporated herein by reference in its entirety.

### BACKGROUND

### 1. Technical Field

The present disclosure relates to a method and an apparatus for supporting driving of a vehicle.

### 2. Description of Related Art

Japanese Unexamined Patent Application Publication No. 2011-73530 discloses a method for supporting driving of a vehicle. In this conventional method, departure preventing control of preventing a vehicle from departing from a road is performed. In this departure preventing control, based on an amount of departure from a virtual lane configured on the road, a target yaw moment for returning the vehicle to the virtual lane is calculated. The target yaw moment is distributed to a brake control apparatus and a steering control apparatus. The brake control apparatus controls a brake so as to generate a yaw moment according to the target yaw moment after the distribution. Meanwhile, the steering control apparatus converts the target yaw moment after the distribution into assist steering torque, and controls steering so as to generate torque based on the assist steering torque.

### SUMMARY

A method for supporting driving of a vehicle includes control performed in a situation that the vehicle is likely to collide with an obstacle. In the present application, driving support control is considered that is performed in a situation that occurs at an earlier stage than that in such driving support control, that is, a situation in which there is not a high possibility that the vehicle will collide with an obstacle. This driving support control is performed, with a pedestrian or the like ahead of the vehicle regarded as a risk factor, for avoiding the risk factor. Such driving support control is called risk avoiding control in the present application.

In the case of a vehicle including a function of performing the departure preventing control and a function of performing the risk avoiding control, it is independently determined whether or not each of operative conditions for these kinds of driving support control is satisfied. There arises a problem when the operative conditions for these kinds of driving support control are satisfied in the same period. Note that the problem is expected to be solved by starting, immediately after one of these kinds of driving support control that is started earlier is ended, the other of these kinds of driving support control.

One can consider that the problem does not arise when the operative condition for the departure preventing control and the operative condition for the risk avoiding control are satisfied separately at some interval between those. However, when a time until the risk avoiding control is started after the departure preventing control is ended is a few seconds, a series of movements of the vehicle from just before the end of the departure preventing control until immediately after the start of the risk avoiding control are awkward and lack a feeling of integration. This leads to a high possibility that the series of movements give a driver of the vehicle a feeling of distrust.

An object of the present disclosure is to provide a technology, for a vehicle including a function of performing departure preventing control and a function of performing risk avoiding control, to restrain a series of movements of the vehicle from just before the end of the departure preventing control until immediately after the start of the risk avoiding control from giving a driver of the vehicle a feeling of distrust.

A first aspect of the present disclosure is a method for supporting driving of a vehicle and has the following features. The method includes: a step of performing departure preventing control including steering control for preventing the vehicle from departing from a driving lane for the vehicle; and a step of starting, when an operative condition for risk avoiding control including steering control for avoiding a risk factor ahead of the vehicle is satisfied during performance of the departure preventing control, the risk avoiding control from an end timing of the departure preventing control. The operative condition for the risk avoiding control includes that a longitudinal distance from the vehicle to the risk factor is not more than a reference distance. The method further includes a step of expanding the reference distance during performance of the departure preventing control.

A second aspect of the present disclosure is an apparatus for supporting driving of a vehicle and has the following features. The apparatus includes a processor configured to perform various kinds of processing. The processor is configured to perform processing of performing departure preventing control including steering control for preventing the vehicle from departing from a driving lane of the vehicle, and processing of starting, when an operative condition for risk avoiding control including steering control for avoiding a risk factor ahead of the vehicle is satisfied during performance of the departure preventing control, the risk avoiding control from an end timing of the departure preventing control. The operative condition for the risk avoiding control includes that a longitudinal distance from the vehicle to the risk factor is not more than a reference distance. The processor is further configured to perform processing of expanding the reference distance during performance of the departure preventing control.

According to the aspects of the present disclosure, the reference distance included in the operative condition for the risk avoiding control is expanded during performance of the departure preventing control. The operative condition for the risk avoiding control includes that the longitudinal distance from the vehicle to the risk factor is not more than the reference distance. Therefore, when the reference distance is expanded, the operative condition for the risk avoiding control becomes readily satisfied. By doing so, in a situation that, after the end of the departure preventing control, a waiting time occurs until the start of the risk avoiding control if such expansion does not exist, the risk avoiding control may be started from the end timing of the departure preventing control. Therefore, it may be restrained that a series of movements of the vehicle from just before the end of the departure preventing control until immediately after the start of the risk avoiding control give a driver of the vehicle a feeling of discomfort.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining risk avoiding control;

FIG. 2 is a diagram for explaining risk avoiding control;

FIG. 3 is a diagram for explaining departure preventing control;

FIG. 4 is a diagram for explaining departure preventing control;

FIG. 5 is a diagram for explaining features of an embodiment;

FIG. 6 is a diagram for explaining features of the embodiment;

FIG. 7 is a diagram for explaining features of the embodiment;

FIG. 8 is a diagram for explaining features of the embodiment;

FIG. 9 is a block diagram showing a configuration example of a driving support apparatus according to the embodiment; and

FIG. 10 is a flowchart showing processing, performed by a control apparatus, especially relevant to the embodiment.

### DETAILED DESCRIPTION OF EMBODIMENTS

Hereinafter, a driving support method, a driving support apparatus, and a driving support program for a vehicle according to an embodiment of the present disclosure will be described with reference to the drawings.

### 1. Driving Support Control

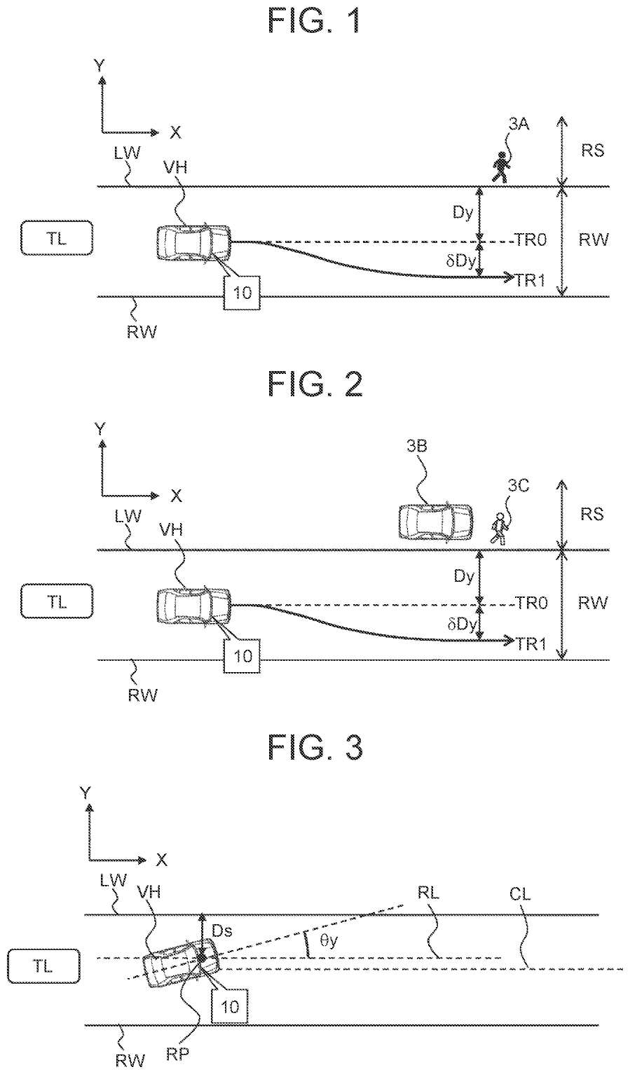

FIGS. 1 to 4 are diagrams for explaining driving support control performed in the embodiment. A driving support apparatus 10 according to the embodiment performs “driving support control” for supporting driving of a vehicle VH. This driving support control may be included in autonomous driving control. The driving support apparatus 10 is typically mounted on the vehicle VH. At least part of the driving support apparatus 10 may be arranged in an external apparatus (for example, an external server) outside the vehicle VH to perform the driving support control in a remote manner. That is, the driving support apparatus 10 may be dispersedly arranged in the vehicle VH and the external apparatus.

The driving support control includes “risk avoiding control” for avoiding a risk factor 3 ahead of the vehicle VH. The risk avoiding control is also called proactive driving assist (PDA) control. In the risk avoiding control, in order to avoid the risk factor 3 ahead of the vehicle VH, the driving support apparatus 10 automatically performs at least one of steering and deceleration of the vehicle VH. For example, in FIG. 1, the vehicle VH is travelling in a traffic lane TL in a roadway RW. The traffic lane TL is defined by a left white line LW and a right white line RW provided on the roadway RW. The traffic lane TL corresponds to a “driving lane for a vehicle” in the present disclosure. A road shoulder RS is adjacent to the traffic lane TL. There is a possibility that a pedestrian 3A present on the road shoulder RS ahead of the vehicle VH will enter the roadway RW. Accordingly, the pedestrian 3A may be regarded as the risk factor 3.

In the example shown in FIG. 1, the risk avoiding control includes “steering support control” to automatically perform steering of the vehicle VH so as to avoid the pedestrian 3A beforehand. The risk avoiding control may include “deceleration support control” to automatically perform deceleration of the vehicle VH so as to avoid the pedestrian 3A beforehand. In the steering support control, the driving support apparatus 10 steers the vehicle VH in a direction away from the pedestrian 3A. The pedestrian 3A may be replaced by a bicycle or a two-wheeled vehicle. Moreover, the risk factor 3 also includes a pedestrian, a bicycle, a two-wheeled vehicle, and the like present on the roadway RW as well as on the road shoulder RS.

FIG. 2 is a diagram for explaining another example of the risk avoiding control. The risk factor 3 is not limited to an “explicit risk” such as the pedestrian 3A shown in FIG. 1. The risk factor 3 can include a “latent risk”. For example, in FIG. 2, a parked vehicle 3B is present on the road shoulder RS ahead of the vehicle VH. An area ahead of the parked vehicle 3B is in a blind spot of the vehicle VH, and there is a possibility that a pedestrian 3C rushes out from the blind spot. Accordingly, each of the parked vehicle 3B and the pedestrian 3C may be regarded as the risk factor 3 (latent risk).

In the example shown in FIG. 2, the risk avoiding control includes steering support control to automatically perform steering of the vehicle VH so as to avoid the parked vehicle 3B beforehand. In this steering support control, the driving support apparatus 10 steers the vehicle VH in a direction away from the parked vehicle 3B. Notably, as with the example shown in FIG. 1, the risk avoiding control may include deceleration support control.

A vehicle coordinate system (X, Y) is herein defined. The vehicle coordinate system (X, Y) is a relative coordinate system that is fixed onto the vehicle VH, and changes along with motion of the vehicle VH. The X-direction is a forward direction (travelling direction) of the vehicle VH. The Y-direction is a transverse direction of the vehicle VH. The X-direction and the Y-direction are perpendicular to each other.

In FIGS. 1 and 2, a trajectory TR0 represents a travelling trajectory of the vehicle VH in the case where the steering support control is not performed. When the steering support control is not performed, it is assumed that the vehicle VH travels in parallel with the traffic lane TL. Accordingly, the trajectory TR0 extends from a current position of the vehicle VH in parallel with the traffic lane TL. In the following description, a transverse distance Dy is the shortest distance between the trajectory TR0 and the risk factor 3. In other words, the transverse distance Dy is a Y-directional distance between the vehicle VH (trajectory TR0) and the risk factor 3 at the time when the vehicle VH passes by a side of the risk factor 3.

In FIGS. 1 and 2, a trajectory TRI represents a travelling trajectory of the vehicle VH in the case where the steering support control is performed. When the steering support control is performed, the vehicle VH moves in a direction away from the risk factor 3. An amount of transverse motion δDy is an amount of motion of the vehicle VH originating from the steering support control in the direction away from the risk factor 3. In other words, the amount of transverse motion δDy is an amount of motion of the vehicle VH in the direction away from the risk factor 3, as viewed through the trajectory TR0.

The driving support control also includes “departure preventing control” for preventing the vehicle VH from departing from the traffic lane TL. The departure preventing control is also called lane departure alert (LDA) control. In the departure preventing control, in order to prevent the vehicle VH from departing from the traffic lane TL, the driving support apparatus 10 automatically performs at least one of steering and deceleration of the vehicle VH. For example, in FIG. 3, a front-rear axis of the vehicle VH deviates by an angle θy relative to a reference line RL on the traffic lane TL. The deviation angle θy is an angle formed by the front-rear axis passing through a reference point RP of the vehicle VH and the reference line RL, and is occasionally called yaw angle. The reference line RL is set to pass through the reference point RP along the traffic lane TL. Therefore, there is a case where the reference line RL coincides with a center line CL of the traffic lane TL, or there is a case where the reference line RL does not coincide with the center line CL.

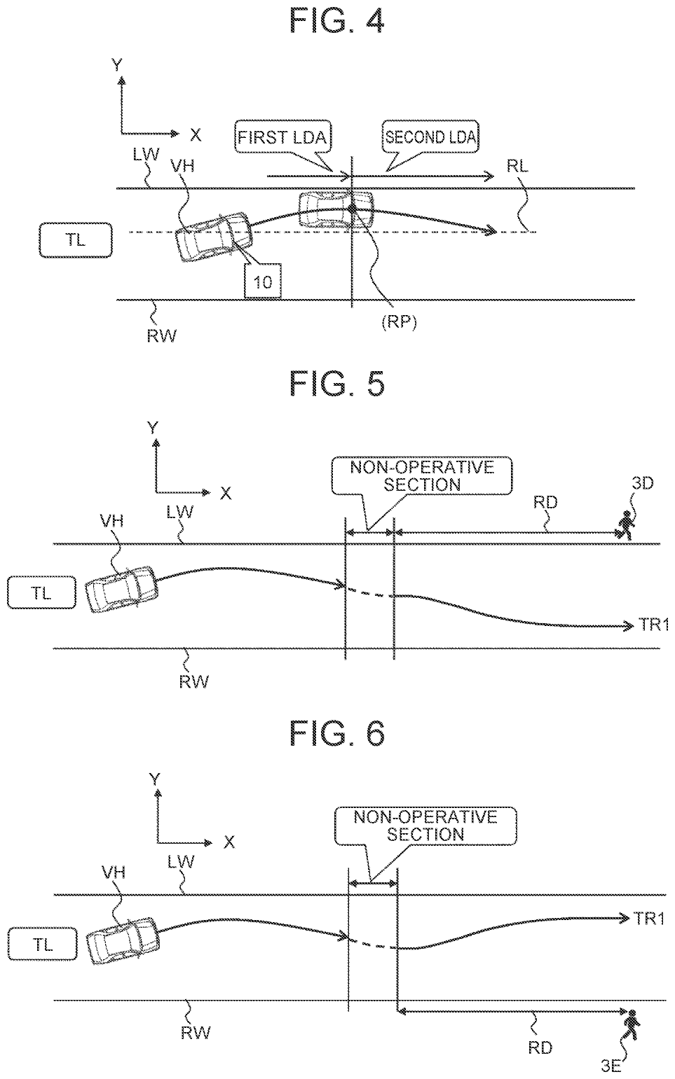

FIG. 3 shows a transverse distance Ds from the reference point RP to the left white line LW. The transverse distance Ds may also be a distance from the reference point RP to the right white line RW. The departure preventing control is performed when the vehicle VH is likely to depart outward from the traffic lane TL. FIG. 4 is a diagram for explaining the departure preventing control. In the example shown in FIG. 4, the departure preventing control includes “steering support control” to automatically perform steering of the vehicle VH such that the vehicle VH does not depart outward from the left white line LW. The departure preventing control may include “deceleration support control” to automatically perform deceleration of the vehicle VH such that the vehicle VH does not go beyond the left white line LW.

In the steering support control, the driving support apparatus 10 steers the vehicle VH in a direction away from the left white line LW. Moreover, the driving support apparatus 10 steers the vehicle VH in a direction coming close to the center line CL. When the vehicle VH is steered in the direction away from the left white line LW, the deviation angle θy illustrated in FIG. 3 decreases. The steering support control includes first control (hereinafter also called “first LDA control”) that is performed until a prescribed angle θy0 at which the front-rear axis of the vehicle VH is regarded as parallel to the reference line RL and the deviation angle θy coincide with each other. Moreover, the steering support control includes second control (hereinafter also called “second LDA control”) that is performed subsequently to the first control. The second control is performed until both the transverse distances Ds in the right-left direction fall within a predetermined range, by steering of the vehicle VH in the direction coming close to the center line CL. Notably, the predetermined range is set in accordance with the transverse width of the traffic lane TL.

### 2. Features of Embodiment

As having been described, when a time until the risk avoiding control is started after the departure preventing control is ended is about seconds (for example, one second to three seconds), a series of movements of the vehicle from just before the end of the departure preventing control until immediately after the start of the risk avoiding control are awkward and lack a feeling of integration. FIGS. 5 and 6 are diagrams for explaining this problem. In the examples shown in FIGS. 5 and 6, the departure preventing control has been already started.

In the example shown in FIG. 5, a pedestrian 3D is present on the road shoulder RS on the left side ahead of the vehicle VH. In the example shown in FIG. 6, a pedestrian 3E is present on the road shoulder RS on the right side ahead of the vehicle VH. Each of the pedestrians 3D and 3E corresponds to the risk factor 3. Note that an operative condition for the risk avoiding control includes that a longitudinal distance DX from the vehicle VH to the risk factor 3 is not more than a reference distance RD. Therefore, the start of the risk avoiding control is to be waited for until a timing when the condition regarding the longitudinal distance is satisfied. During this waiting time, the vehicle VH is to travel in the course of events. Note that this leads to the aforementioned series of movements of the vehicle when a non-operative section where both the departure preventing control and the risk avoiding control do not operate is short.

Therefore, in the embodiment, during performance of the departure preventing control, a process of expanding the reference distance RD is performed. The reference distance RD after the expansion is called “reference distance RD*”. When the reference distance RD is changed to the reference distance RD*, the operative condition for the risk avoiding control becomes readily satisfied during performance of the departure preventing control. Therefore, a situation that the start of the risk avoiding control is waited after the end of the departure preventing control may be restrained.

When the operative condition for the risk avoiding control is satisfied during performance of the departure preventing control, the risk avoiding control is started from the end timing of the departure preventing control. When the risk avoiding control is started from the end timing of the departure preventing control, the departure preventing control and the risk avoiding control may be consecutively performed. Therefore, it may be restrained that the series of movements of the vehicle VH from just before the end of the departure preventing control until immediately after the start of the risk avoiding control give a driver of the vehicle VH a feeling of discomfort.

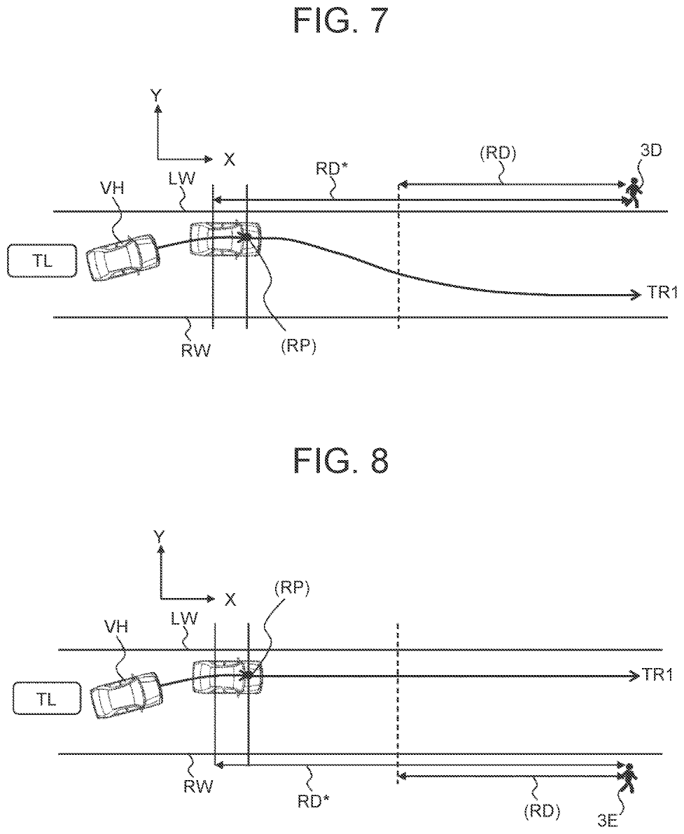

The risk avoiding control may be started from the end timing of the first LDA control described with FIG. 4. FIGS. 7 and 8 are diagrams for explaining the behavior of the vehicle in the case where the risk avoiding control is started from the end timing of the first LDA control. An external environment of the vehicle VH shown in FIG. 7 is the same as that illustrated in FIG. 5. Moreover, an external environment of the vehicle VH shown in FIG. 8 is the same as that illustrated in FIG. 6.

The end timing of the departure preventing control includes the end timing of the second LDA control and the end timing of the first LDA control. When the risk avoiding control is started from the end timing of the second LDA control, the aforementioned effect is expected. Note that the object (departure prevention) of the departure preventing control has been achieved in the end timing of the first LDA control before the end timing of the second LDA control. Therefore, there arises no problem even when the risk avoiding control is started from the end timing of the first LDA control. In the situation shown in FIG. 8, the start of the risk avoiding control from the end timing of the first LDA control rather contributes to stabilization of steering behavior of the vehicle VH.

### 3. Driving Support Apparatus

### 3-1. Configuration Example

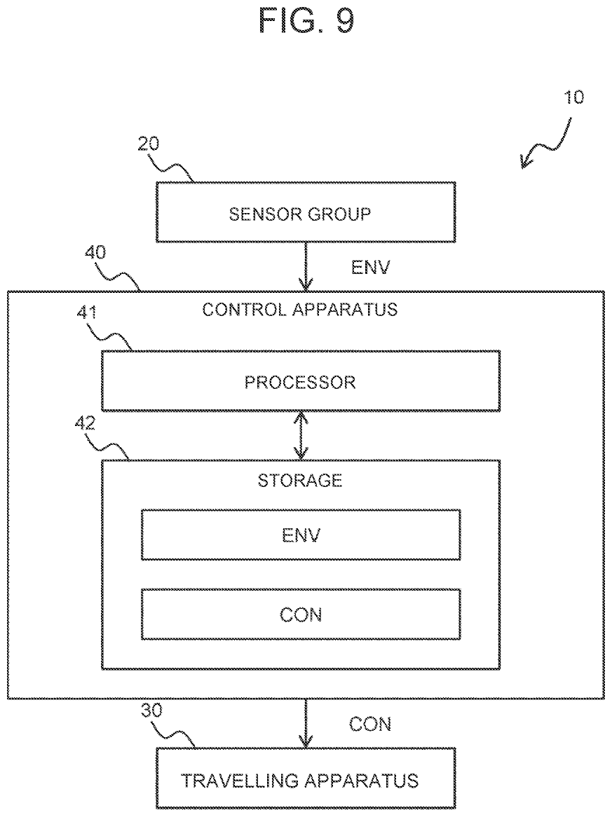

FIG. 9 is a block diagram showing a configuration example of the driving support apparatus 10 according to the embodiment. In the example shown in FIG. 9, the driving support apparatus 10 includes a sensor group 20, a travelling apparatus 30, and a control apparatus 40.

For example, the sensor group 20 includes a position sensor, status sensors, and recognition sensors. The position sensor detects the position and the orientation of the vehicle VH. Examples of the position sensor include a global positioning system (GPS) sensor. The status sensors detect internal states of the vehicle VH. Examples of the status sensors include a vehicle speed sensor, a yaw rate sensor, a transverse acceleration sensor, a steering angle sensor, and the like. The recognition sensors recognize (detect) situations around the vehicle VH. Examples of the recognition sensors include a camera, a radar, a laser imaging detection and ranging (LIDAR), and the like.

Sensors included in the sensor group 20 transmit detected or recognized information to the control apparatus 40. The information transmitted to the control apparatus 40 from the sensors constitutes driving environment information ENV. The driving environment information ENV also includes map information. The map information includes information of arrangement information of traffic lanes, shapes of roads, and the like. For example, the map information is stored in a predetermined storage included in the vehicle VH. The map information may be stored in an external apparatus (for example, an external server) outside the vehicle VH.

The travelling apparatus 30 includes a steering system, a drive line, and a braking device. The steering system steers wheels of the vehicle VH. For example, the steering system includes an electric power steering (EPS) apparatus. The drive line is a motive power source that generates driving force. Examples of the drive line include an engine, a traction motor, an in-wheel motor, and the like. The braking device generates braking force.

The control apparatus 40 controls the vehicle VH. The control apparatus 40 typically is a microcomputer mounted on the vehicle VH. The control apparatus 40 is also called electronic control unit (ECU). The control apparatus 40 may be an external information processing apparatus outside the vehicle VH. In this case, the control apparatus 40 communicates with the vehicle VH and controls the vehicle VH in a remote manner.

The control apparatus 40 includes a processor 41 and a storage 42. The processor 41 performs various kinds of processing. The storage 42 is a volatile memory, a nonvolatile memory, or the like, and stores various kinds of information. Examples of the various kinds of information include the driving environment information ENV. The various kinds of information also include control information CON transmitted to the travelling apparatus 30. By the processor 41 executing a control program as a computer program, the various kinds of processing by the processor 41 are implemented. The control program is stored in the storage 42 or is recorded in a computer-readable recording medium.

### 3-2. Exemplary Processing by Control Apparatus

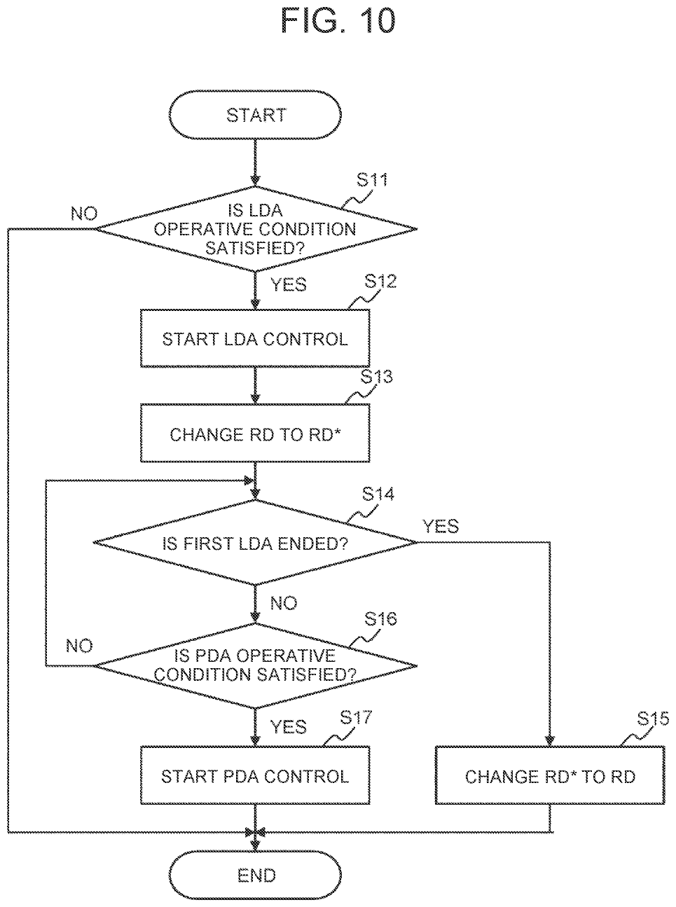

FIG. 10 is a flowchart showing processing, performed by the processor 41, especially relevant to the driving support control. A processing flow shown in FIG. 10 is repeatedly executed in predetermined computation cycles.

In the processing flow shown in FIG. 10, first, it is determined whether or not an LDA operative condition is satisfied (step S11). The LDA operative condition includes various conditions for determining whether or not the vehicle VH is to depart outward from the traffic lane TL. For example, the various conditions include the deviation angle θy and the transverse distance Ds as determination parameters. The various parameters may include that the vehicle VH is approaching a curve.

When the determination result in step S11 is affirmative, the LDA control (that is, departure preventing control) is started (step S12). In the departure preventing control, target torque for causing the vehicle VH not to depart from the traffic lane TL is calculated, for example, based on the deviation angle θy, the transverse distance Ds, a speed of the vehicle VH, a curve radius of the traffic lane TL, a yaw rate of the vehicle VH, and the like. In place of the target torque, a target steering angle for causing the vehicle VH not to depart from the traffic lane TL may be calculated. Then, the control information CON that indicates the target torque (or target steering angle) is transmitted to the travelling apparatus 30 (steering system).

Subsequently to the processing of step S12, the reference distance RD is changed to the reference distance RD* (>RD) (step S13). The process of step S13 may be performed in parallel with the processing of step S12. Notably, the reference distance RD and the reference distance RD* are set to be variable in accordance with the speed of the vehicle VH.

Subsequently to the processing of step S13, it is determined whether or not the first LDA control is ended (step S14). The processing of step S14 is performed, for example, based on whether or not the deviation angle θy decreases to be not more than the prescribed angle θy0. When the determination result in step S14 is affirmative, the reference distance RD* is changed to the reference distance RD (step S15). In other words, the reference distance RD is set to a default value. Notably, in the processing of step S14, it may be determined whether or not the second LDA control, in place of the first LDA control, is ended. In this case, in the processing of step S14, it is determined whether or not both the transverse distances Ds in the right-left direction fall within the predetermined range.

When the determination result in step S14 is negative, it is determined whether or not a PDA operative condition is satisfied (step S16). The PDA operative condition includes various conditions for determining whether or not the vehicle VH has a risk of colliding with an obstacle ahead. The various conditions include that the risk factor 3 is recognized ahead of the vehicle VH. Moreover, the various conditions include that the longitudinal distance DX to this risk factor 3 from the vehicle VH is not more than the reference distance RD (the reference distance RD* when the reference distance RD* is set).

When the determination result in step S16 is negative, the processing of step S14 is performed. In other words, the processing of step S14 and S16 is repeatedly performed until the first LDA control is ended. When the determination result in step S16 is affirmative, the PDA control (that is, risk avoiding control) is started. In the risk avoiding control, a trajectory for moving the vehicle VH in the direction away from the risk factor 3 is generated. Then, the target torque, the target acceleration, and the like of the vehicle VH are calculated such that the vehicle VH is following the trajectory. In place of the target torque, the target steering angle for the vehicle VH to follow the trajectory may be calculated. Then, the control information CON that indicates the target torque (or target steering angle) is transmitted to the travelling apparatus 30 (steering system).

What is claimed is:

1. A driving support method for a vehicle for supporting driving of the vehicle, the method comprising:
a step of performing departure preventing control including steering control for preventing the vehicle from departing from a driving lane for the vehicle; and
a step of starting, when an operative condition for risk avoiding control including steering control for avoiding a risk factor ahead of the vehicle is satisfied during performance of the departure preventing control, the risk avoiding control from an end timing of the departure preventing control, wherein
the operative condition for the risk avoiding control includes that a longitudinal distance from the vehicle to the risk factor is not more than a reference distance, the method further comprising
a step of expanding the reference distance during performance of the departure preventing control.

2. The driving support method for a vehicle according to claim 1, wherein:
the steering control included in the departure preventing control includes
first steering control of steering the vehicle such that a reference line set to pass through a reference point of the vehicle along the driving lane and a front-rear axis of the vehicle are parallel to each other, and
second steering control, performed subsequently to the first steering control, of steering the vehicle such that a transverse position of the vehicle in the driving lane goes toward a center of the driving lane; and
the end timing of the departure preventing control includes an end timing of the first steering control.

3. The driving support method for a vehicle according to claim 1, wherein:
the steering control included in the departure preventing control includes
first steering control of steering the vehicle such that a reference line set to pass through a reference point of the vehicle along the driving lane and a front-rear axis of the vehicle are parallel to each other, and
second steering control, performed subsequently to the first steering control, of steering the vehicle such that a transverse position of the vehicle in the driving lane goes toward a center of the driving lane; and
the reference distance is expanded during performance of the first steering control.

4. A driving support apparatus for a vehicle for supporting driving of the vehicle, the apparatus comprising
a processor configured to perform various kinds of processing, wherein:
the processor is configured to perform
processing of performing departure preventing control including steering control for preventing the vehicle from departing from a driving lane for the vehicle, and
processing of starting, when an operative condition for risk avoiding control including steering control for avoiding a risk factor ahead of the vehicle is satisfied during performance of the departure preventing control, the risk avoiding control from an end timing of the departure preventing control;
the operative condition for the risk avoiding control includes that a longitudinal distance from the vehicle to the risk factor is not more than a reference distance; and
the processor is further configured to perform
processing of expanding the reference distance during performance of the departure preventing control.
